(19) United States
(12) Patent Application Publication
(10) Pub. No.: US 2010/0046010 A1
(43) Pub. Date: Feb. 25, 2010

(54) METHOD AND DEVICE FOR PRODUCING CUSTOMIZED PRINTED SURFACES

(76) Inventor: Jörg R. Bauer, Weingarten (DE)

Correspondence Address: J-TEK LAW PLLC, 601 Pennsylvania Avenue, NW, Suite 900, South Building, Washington, DC, 20004, US

(21) Appl. No.: 12/517,531

(22) PCT Filed: Nov. 27, 2007
(86) PCT No.: PCT/EP07/10295

§ 371 Date: Jun. 3, 2009

(30) Foreign Application Priority Data
Dec. 8, 2006 (DE) 10 2006 057 961.5

(51) Int. Cl. G06K 15/02; B41J 2/00

(52) U.S. Cl. 358/1.2; 347/110; 358/1.6; 358/1.9

(57) ABSTRACT

A method and device are disclosed for producing individualized patterns from a genre-specific prototype pattern. The prototype pattern is stored in the form of electronically-readable prototype pattern data and individualized pattern data is generated from the prototype pattern data by electronic data processing. The individualized pattern data is modified relative to the prototype pattern data such that the individualized patterns differ from the prototype pattern but the genre of the pattern is still visually recognizable.

The invention relates to a method for producing customized surfaces using a programmable printing method, more particularly an ink jet printing method, by printing the particular surface with at least one individualized pattern derived from a genre-specific prototype pattern. The invention further relates to a method for producing a plurality of components having such surfaces, as well as to a device for printing components with such surfaces.

Modern production methods increasingly permit the simulation of real wood parts, e.g. parquet elements, using components having printed surfaces that are as similar to the real wood surfaces as possible. It is a characteristic of such components that the patterns printed thereon are identical to each other or originate from a limited inventory of patterns so that they recur, if necessary, in irregular intervals.

It is a characteristic of nature that natural surfaces of a specific type, e.g. the surface of a zebra, the surface of wood, the surface of a marble plate, etc. are always recognizable as belonging to the specific type; however, the surfaces or sub-areas of a natural component are never identical. Similar to fingerprints, which are immediately recognizable as fingerprints, two fingerprints originating from different persons or from different fingers of one person are not identical, so that they can serve to individually identify a person.

Modern possibilities for digital image editing are described in the article http://de.wikipedia.org/wiki/Bildbearbeitung. The aim of the image editing mentioned in the citation is the application-specific modification of an image into an image corresponding to the prototype image, which image either satisfies particular requirements with regard to the aesthetic design or is modified such that information contained therein can be plotted in a simple manner.

DE 195 23 714 C1 describes a method for producing glazings and a glazing, in which an optimal imitation of an existing old glazing can be achieved. Herein, existing patterns and/or ornamentations of a particular glazing are plotted via a scanner and using computer technology, and subsequently are incorporated into a special film by a cutting plotter. By the permanent connection of the special film with a glass, a film-glass-glazing is created, which is then converted into specific speciality glazings. All in all, a faithful imitation of an existing old glazing is created for the use in new or renovated buildings, wherein the respective structural-engineering requirements are satisfied.

The publication DE197 53 816 A1 describes a method for producing a coating from natural malachite stone or malachite-like materials and for coating objects.

It is an object of the invention to provide possibilities such that printed surfaces can be created in a cost-effective manner using a programmable printing method, more particularly an ink jet printing method, which printed surfaces are recognizable as belonging to a genre, but are customized, similar to surfaces occurring in nature, i.e. they differ from each other.

A solution of this object is achieved by a method according to claim 1.

Using the inventive method, individualized pattern data can be produced from a prototype pattern stored in the form of electronically-readable prototype pattern data by electronic data processing, which individualized pattern data are modified relative to the prototype pattern data such that the individualized pattern data are individually different, but are still recognizable after printing as a genre-specific pattern.

The features of claims 2 and 3 are directed to advantageous options such that a prototype pattern or a single pattern can be modified according to certain principles, without its genre-specific features being lost.

The degree of modification of a particular parameter in a modification step, e.g. a degree of distortion, a modification of contrast or a displacement of a cutout, can be variable according to claim 4, so that the particularly-modified pattern only slightly differs from its predecessor, or is noticeably modified as compared to the predecessor.

According to claim 5, a feedback between customer-acceptance and the respective patterns to be printed can be achieved.

Using the features of claims 6 and 7, a pattern can be achieved that can be formed with arbitrary lengths, without discontinuities appearing within the pattern.

According to claims 8 to 12, the inventive method can be utilized in different ways for the production of individualized differing components.

According to claim 13, a twofold customization can be achieved by printing a natural, genre-specific surface with an inventively-produced pattern that belongs to the same genre and through which the natural surface shows.

The method according to claim 14 is particularly advantageous for printing wooden surfaces.

Using the features of claim 15, replacement components can be produced.

According to claim 16, customized floor covering planks can be produced.

Claim 17 denotes the constitution of an advantageous device for printing objects with inventively-produced, customized surfaces.

In the following, the invention will be explained in an exemplarily manner and in further detail with the assistance of schematic drawings.

In the figures:

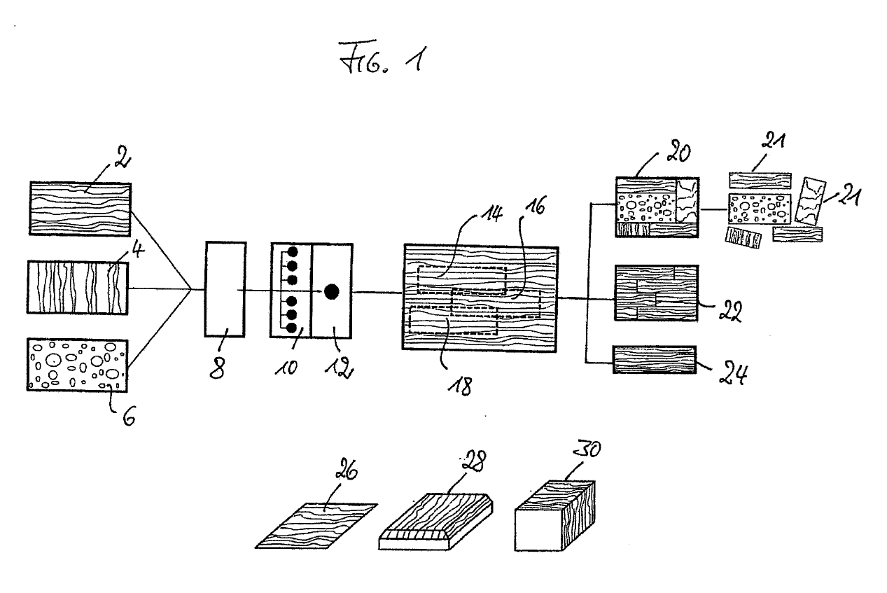

FIG. 1 shows various patterns, the generation of individualized patterns from the prototype patterns, the printing of the individualized patterns on surfaces, as well as components provided with the patterns,

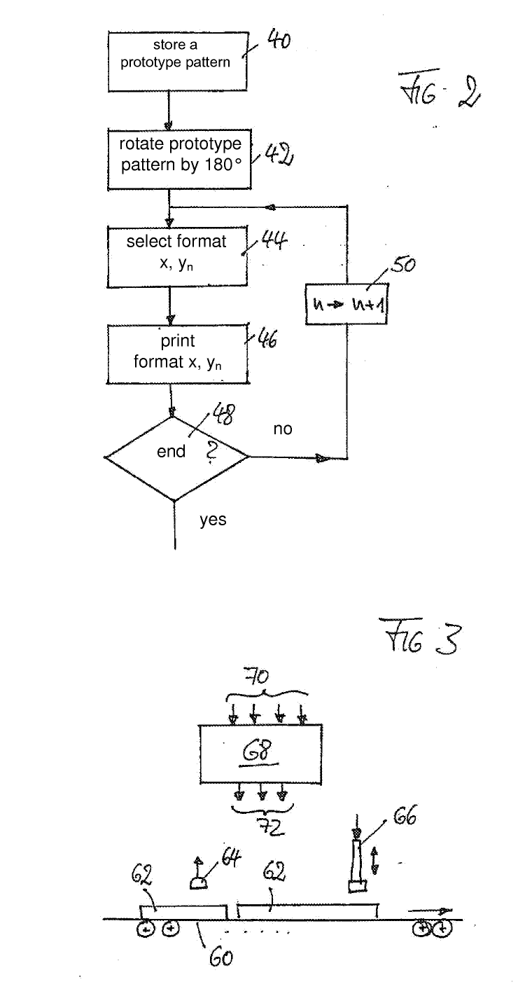

FIG. 2 shows a flow chart for explaining an inventive method,

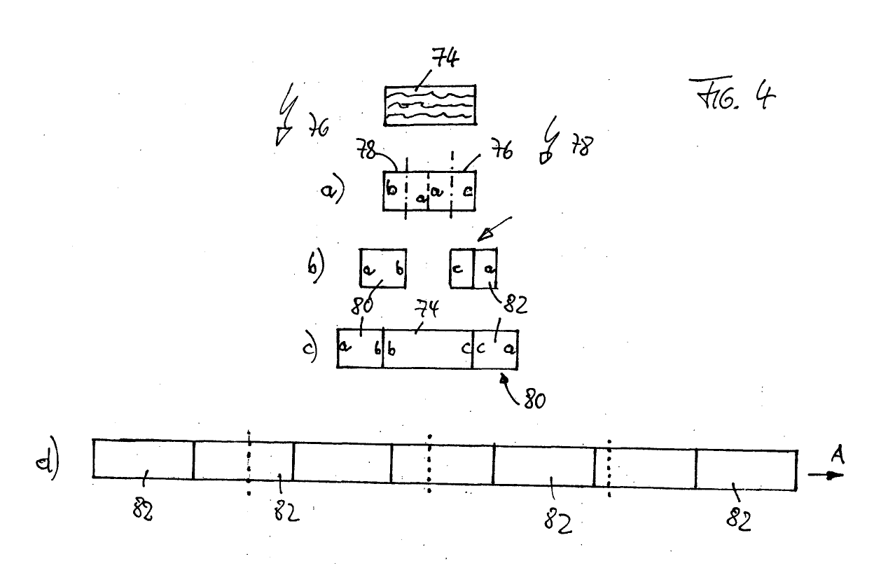

FIG. 3 shows a schematic diagram of an inventive device and

FIG. 4 shows schematic drawings for explaining the production of a pattern element and its application.

Reference numerals 2, 4 and 6 in FIG. 1 denote archetypes and/or graphic prototype patterns that are produced synthetically or that may be surfaces of natural objects, such as wooden surfaces, marble or other stone surfaces, leather surfaces or also cloth materials or other kinds of surfaces that form a genre, etc. Unless they were not produced in a data processing device (e.g. wallpaper pattern), these prototype patterns are written into a data processing device, e.g. using electronic photography, scanning etc. and are available there in the form of prototype pattern datasets 8. Such a prototype pattern dataset can be modified in a data processing device in a known manner, for example by rotating the prototype pattern stored therein about an axis, e.g. an axis extending perpendicular to the surface of the pattern, mirroring it about an axis in the plane of the pattern, distorting and/or extending or compressing it in a longitudinal or transverse direction of the pattern, enlarging or reducing it as a whole, brightening or darkening the colour or degree of blackness of the pattern, such as at a change of illumination, modifying the contrast of the pattern or modifying the color curve. Said data processing of the prototype pattern dataset is carried out in a prototype pattern processing section 10 of the data processing device and results in that a prototype pattern dataset different from prototype pattern dataset 8 is available in a database 12.

Subsequently, individualized pattern datasets 14, 16 and 18 are produced from the modified prototype pattern dataset available in the database 12, taking into account the size of a surface to be printed on, which individualized pattern datasets correspond to different geometrical portions of the modified prototype pattern dataset 12 stored in the database 12. These individualized pattern datasets, which differ from each other with regard to their patterning, are subsequently printed on a component to be printed on and/or a surface to be printed on.

A component is denoted by 20, on which individualized patterns originating from different prototype patterns are printed, wherein the individualized patterns are advantageously provided with border lines having a predetermined thickness, so that the component 20 can be separated into individual parts 21, whose surfaces are respectively printed with one of the individual patterns derived from one of the prototype patterns 2, 4 or 6. The component 20 may also be further used as a whole.

The component 22 is, for example, a parquet panel, with which four adjacent real wood planks are simulated. Herein, the individualized patterns are also provided with thin border lines that simulate the different planks.

The component 24 is, for example, a single parquet block, wherein the inventive generation of individualized patterns makes it possible that no parquet blocks are produced with identical surfaces.

The inventively-generated individualized patterns may be used for the two-dimensional printing of a planar surface, e.g. a planar surface 26 of a wooden plate or a decorative paper; they may also be used for the three dimensional printing of differently-shaped components, such as the components 28 or 30. The component 28 has chamfered edges. The component 30 is cuboid.

The inventively-generated individualized patterns may be used, e.g., for floors, wooden panels, furniture parts, wall- and ceiling-elements. Wooden surfaces, leather surfaces, stone surfaces, papers, metals, glass, fabric and plastics can be printed using the inventively-generated individualized pattern datasets. It is possible to print two-dimensional components (e.g. component 26), components having a relief-surface, wherein this can take place with one or more print heads, or components in a 3-D method (component 30). Herein, all types of print head guides and relative movements between the components and the print heads are possible. The surfaces of the components to be printed are advantageously completely machined before printing. The printing of surfaces may be combined with embossing of the surfaces, which advantageously takes place before printing. After printing, the surfaces may be painted or laminated.

FIG. 2 shows an example of a process for producing individualized patterns: In step 40, a prototype pattern is written into the memory of a data processing device, and a prototype pattern dataset is produced (cf. reference numeral 8 in FIG. 1).

In step 42, the prototype pattern is rotated by 180° around a central axis extending perpendicular thereto. This step is carried out in the prototype pattern processing section 10 (FIG. 1). In step 44, a shape, i.e. a surface section of predetermined size, is selected from the prototype pattern modified in step 42, which surface section is defined by the coordinates x, yₙ of a corner.

In step 46 the individualized pattern dataset selected in step 44 is printed.

In step 48, e.g. the number of printing tasks to be carried out, reaching an edge of the prototype pattern etc., whether a loop should be entered or not, is determined with the assistance of predetermined criteria. If the end is not reached yet, a loop is entered, in which the y-coordinate is modified by a predetermined increment in step 50. Subsequently, in step 44, a new shape with the corner-coordinates x, y₍ₙ₊₁₎ is selected from the prototype pattern dataset, which is then printed in step 46 etc.

The method described in FIG. 2 is merely exemplary. The variety of datasets, which are producible from a prototype pattern dataset (2, 4, 6 (FIG. 1)) using the inventive method, is unlimited. Initially, for example, individualized patterns may be produced directly from the prototype pattern by selecting pattern sections lying within the prototype pattern according to certain principles (respective progression of an x- and/or a y-coordinate), and after a predetermined number of selected individualized datasets, the prototype pattern as a whole is processed in the prototype pattern processing device 10, whereupon individualized pattern datasets are again produced from the modified prototype pattern dataset, etc. The respective parameter, which is varied in the prototype pattern in a processing step carried out in the prototype pattern processing device 10, does not have to be the same in every processing step, but rather may be varied, whereby the variation of each individualized pattern from one another can be influenced. The geometrical displacement of the individualized pattern datasets selected from a prototype pattern dataset or a modified prototype pattern dataset can also be periodically, stochastically or temporally controlled with the number of retrieved individualized patterns changing.

Further individual patterns may also be produced from an individualized pattern produced from the prototype pattern, by processing them according to one or more of the above-stated methods. The stated methods, such as rotating about an axis, mirroring, enlarging or reducing, distorting, modification of color towards lighter or darker, modification of contrasts or modification of color-curves, are known in the processing of electronically stored data, e.g. texts, and are, therefore, not explained in detail. In this processing, the generic character of the original pattern, e.g. the appearance of a wooden surface, may be preserved, wherein the natural appearance may be lost due to color interferences and/or color changes or contrast changes, because the respective colour or combination of colours does not exist in nature; the pattern, however, is nevertheless categorized or recognized as a zebra-pattern, wood-pattern, stone-pattern etc.

The prototype pattern and/or individual patterns modified in the prototype pattern processing device 10 may, for example, be stored in a customer-accessible database of a not illustrated device, in which surfaces of components are printed with the patterns according to the customer's wish, and can be made visible on a display or printed out in a printing device. If an individualized pattern is highly accepted by customers, the respective parameter, which was utilized in the processing step carried out in the prototype pattern processing device 10, and which led to the respective individualized pattern, may be reduced, so that a feedback between customer acceptance and the size of the modification of a respective modification step is carried out, so that individualized patterns, which meet with maximum customer acceptance, are produced in the prototype pattern processing device 10.

A transport device is denoted with 60, e.g. a conveyor belt, on which objects 62 to be printed are linearly conveyed. A sensor device is denoted with 64, which advantageously recognizes the geometrical position of the objects 62 in the longitudinal and width directions of the transport device 60 and additionally recognizes the height of the objects 62. A print head is denoted with 66, which is, for example, movable in the height-direction and the width direction of the transport device 60 and belongs to a not illustrated printing device. An electronic control device is denoted with 68, in which the individualized patterns are produced as explained above, and whose inputs 70 are connected with the sensor device 64 and, if necessary, with further external devices, such as order input data transmitters etc., and whose outputs 72 are connected to the printing device. The printing device may comprise one or more print heads, wherein the print heads may be pivotable, so that the upper surface as well as the side surfaces of the objects may be printed using a single print head. The device may also be designed such that the one or, preferably, the plurality of print heads is fixedly arranged and the particular object to be printed on is moved relative to the print head(s).

For later identification of the respective printed object and the pattern printed thereon, with the respective data set, the object is advantageously printed with a marking that identifies it and the pattern data set. Hence, in case of a later re-ordering of objects, replacement objects can be produced, which are printed with a pattern that corresponds exactly to the original object. The marking may be provided on a side surface or on a bottom surface of the respective object.

The individual functions of the devices shown in FIG. 3 are known and are not explained in detail.

An advantageous design of the electronic control device may be such that a pattern data set required for the printing is always subsequently deleted from the database when it is not longer required for printing, and a respectively new, individualized different dataset of the same type is produced, while the printing is carried out with an existing data set, or immediately after the printing with a previous dataset, from which the new dataset is produced as the case may be, is finished. In this way, storage space is saved in the data processing device.

In the following, a possibility is explained with the assistance of FIG. 4, how a pattern element can be produced from an individualized pattern, which may be applied with an unlimited length, similar to the conventional coating, e.g. of a wallpaper pattern using a roller, whose surface is provided with a continuous, i.e. without breaks, pattern:

An individualized pattern with a rectangular shape is denoted with 74. This individualized pattern is stored in an individualized pattern dataset and is processed in the processing device 10, which is called a prototype pattern processing device in the example of FIG. 1, in which device datasets corresponding to individualized patterns may, however, be further processed:

First of all, as shown in a), the individualized pattern 74 is divided into two pattern-halves 76 and 78 by its dashed central line. Edges of the pattern halves, which border on each other, are denoted with a; b and c denote the edges of the pattern halves that face away from each other.

In step b) the pattern halves 76 and 78 are mirrored about the dash-dotted lines of figure part a), so that the border line b of the left pattern half 76 changes sides with the borderline a, and the borderline a of the right pattern half 78 likewise changes sides with the borderline a. Hence, two mirrored pattern halves 80 and 82 are created. If the mirrored pattern halves are then respectively joined to the outside of the individualized pattern 74, as illustrated in figure part c), a pattern element 80 derived from the individualized pattern 74 is created, whose pattern lines continuously extend in the longitudinal direction of the pattern (b to b and c to c), which, joined to each other as a whole, results in a continuously extending pattern, as its outer border lines a correspond to each other.

In figure part d), a series of components 82, which are arranged abutting one another, is schematically shown, which are, for example, conveyed on the conveying device 60 (FIG. 3) in the direction of arrow A. Assuming that the printing device and the print head 66, respectively, are actuated exactly at the time when the first component 82 passes beneath it, and the width of the pattern element 80 is exactly the same as the width of the components 82, wherein the print head starts with the printing exactly at a forward corner of the first component 82, then pattern elements 80, which are the same as one another, can be printed on the series of components 82; the pattern elements 80 continuously transition into each other at the illustrated dotted vertical lines (a left border line a shown in FIG. 4c is followed by a right border line a shown in FIG. 4c). If the length of a component 82 is not divisible by the length of a pattern element 80, then each pattern element 80 is aligned differently relatively to a component 82 with respect to its length, so that a plurality of different components 82 can be produced using one pattern element. In is understood that, by electronically modifying the individualized pattern 74, a plurality of pattern elements 80 can be produced.

The method described with the assistance of FIG. 4 is particularly suitable for producing relatively long wooden planks of a plank wooden floor, since large surfaces can be covered with wooden planks, which differ from each other with respect to their patterns, based on a single individualized pattern or a few electronically-modified individualized patterns or natural individualized pattern templates.

All in all, the invention makes it possible to produce an infinite number of individualized patterns from one prototype pattern, which are individually different but are immediately recognizable as belonging to the same genre as the prototype pattern. It is understood that, plural prototype patterns belonging to a single genre may also be provided, from which the individual patterns are produced. Further individualized patterns of the same genre may also be produced from the individualized patterns by electronic data processing. From a limited inventory of natural pattern templates, an infinite variety of surfaces and/or components, which are individually different in their appearance but are of the same genre, can be produced.

### LIST OF REFERENCE NUMBERS

2 prototype pattern

4 prototype pattern

6 prototype pattern

8 prototype pattern dataset

10 prototype pattern processing device

12 database

14 individualized pattern dataset

16 individualized pattern dataset

18 individualized pattern dataset

20 component

21 part

22 parquet element

24 parquet block

26 planar surface

28 component

30 component

60 transport device

62 object

64 sensor device

66 print head

68 electronic control device

70 inputs

72 outputs

74 individualized pattern

76 pattern half

78 pattern half

80 pattern element

82 component

1-17. (canceled)

18. A method for printing a surface, comprising:
providing an electronically-readable prototype pattern data set that includes data representing a prototype pattern of a naturally-occurring surface appearance of a predetermined genre,
electronically modifying the prototype pattern data set using at least one modification step selected from:
a) rotating about an axis,
b) mirroring,
c) enlarging or reducing,
d) distorting,
e) lightening or darkening the color,
f) changing the contrast, and
g) changing the color-curve,
to generate a first individualized pattern data set that represents a first individualized pattern, such that the first individualized pattern differs from the prototype pattern, but is still visually recognizable, when printed, as the same genre as the prototype pattern, and
printing the first individualized pattern on the surface using the first individualized pattern data set.

19. A method according to claim 18, further comprising varying a value of at least one parameter utilized in said modification step(s) in order to generate a series of differing individualized patterns derived from at least one of the prototype pattern data set and a previously-generated individualized pattern data set.

20. A method according to claim 19, further comprising determining a customer acceptance value for an individualized pattern generated by the modification step(s) and reducing the magnitude of the variation of the value of the at least one parameter utilized in said modification step(s) when the customer acceptance value is above a predetermined threshold.

21. A method according to claim 18, further comprising printing the surface using an ink jet printer.

22. A method according to claim 18, further comprising:
electronically modifying the prototype pattern data set using at least one modification step selected from:
a) rotating about an axis,
b) mirroring,
c) enlarging or reducing,
d) distorting,
e) lightening or darkening the color,
f) changing the contrast, and
g) changing the color-curve,
to generate a second individualized pattern data set that represents a second individualized pattern, such that the second individualized pattern differs from the first individualized pattern and the prototype pattern, but is still visually recognizable, when printed, as the same object genre as the first individualized pattern and the prototype pattern, and
printing the first and second individualized patterns on the surface using the generated first and second individualized pattern data sets.

23. A method according to claim 22, further comprising printing a borderline between the first and second individualized patterns.

24. A method according to claim 18, wherein the step of generating the first individualized pattern data set further comprises producing a pattern element from the first individualized pattern and assembling a continuous sequence of pattern elements with a continuous progression of its pattern along edges that border on each other.

25. A method according to claim 18, wherein the first individualized pattern has a rectangular shape and wherein the step of generating the first individualized pattern data set further comprises producing a pattern element from the first individualized pattern by dividing the individualized pattern into two halves along a plane perpendicular to its direction of extension, mirroring the resulting individualized pattern halves about a central line extending perpendicular to the extension direction, and joining the mirrored individual pattern halves to each other in a flush manner, thereby forming the pattern element.

26. A method according to claim 18, wherein the surface to be printed is a natural object having a surface appearance of the same genre as the prototype pattern and the printing step is performed such that the surface appearance of the natural object is at least partially visible through the printed individualized pattern.

27. A method according to claim 26, wherein the surface is a wooden surface of one type of wood and the individualized pattern is generated from the prototype pattern of another type of wood.

28. A method according to claim 27, further comprising:
electronically modifying the prototype pattern data set using at least one modification step selected from:
a) rotating about an axis,
b) mirroring,
c) enlarging or reducing,
d) distorting,
e) lightening or darkening the color,
f) changing the contrast, and
g) changing the color-curve,
to generate a second individualized pattern data set that represents a second individualized pattern, such that the second individualized pattern differs from the first individualized pattern and the prototype pattern, but is still visually recognizable, when printed, as the same object genre as the first individualized pattern and the prototype pattern, and
printing the first and second individualized patterns on the surface using the generated first and second individualized pattern data sets.

29. A method according to claim 28, further comprising printing the surface using an ink jet printer.

30. A method according to claim 29, further comprising varying a value of at least one parameter utilized in said modification step(s) in order to generate a series of differing individualized patterns derived from at least one of the prototype pattern data set and a previously-generated individualized pattern data set.

31. A method according to claim 30, further comprising determining a customer acceptance value for an individualized pattern generated by the modification step(s) and reducing the magnitude of the variation of the value of the at least one parameter utilized in said modification step(s) when the customer acceptance value is above a predetermined threshold.

32. A method according claim 18, further comprising printing a marking on the surface that identifies the object and the individualized pattern printed on the object.

33. A method for producing a plurality of components having individualized surfaces comprising:
arranging the components one behind the other in a row and abutting each other, and
printing the components with a plurality of assembled pattern elements generated according to claim 24, wherein the components have a length that is not evenly divisible by the length of one pattern element.

34. A method for producing a plurality of components having individualized surfaces comprising:
arranging the components one behind the other in a row and abutting each other, and
printing the components with a plurality of assembled pattern elements generated according to claim 25, wherein the components have a length that is not evenly divisible by the length of one pattern element.

35. An apparatus for printing individualized patterns on objects, comprising:
at least one printer head,
a transport device configured to generate a relative movement between the printer head and the objects and,
a memory storing at least one prototype pattern dataset that includes data representing a prototype pattern of a naturally-occurring surface appearance of an object of a predetermined genre,
a processor configured to generate a plurality of individualized pattern datasets from the stored at least one prototype pattern dataset by electronically modifying the prototype pattern data set using at least one modification step selected from:
a) rotating about an axis,
b) mirroring,
c) enlarging or reducing,
d) distorting,
e) lightening or darkening the color,
f) changing the contrast, and
g) changing the color-curve, and
such that individualized patterns represented by the plurality of generated individualized pattern data sets differ from the prototype pattern, but are still visually recognizable, when printed, as the same genre as the prototype pattern,
a controller configured to control the printer head and the transport device such that the objects are printed according to the generated individualized pattern data sets.

36. A plurality of components, each having a surface printed at least partially with a different individualized pattern, wherein the different individualized patterns are derived from a common prototype pattern that represents a surface of a naturally-occurring object of a predetermined genre, the common prototype pattern being modified by at least one of the following:
a) rotating about an axis,
b) mirroring,
c) enlarging or reducing,
d) distorting,
e) lightening or darkening the color,
f) changing the contrast, and
g) changing the color-curve, and
such that the individualized patterns differ from the prototype pattern, but are still visually recognizable as the same genre as the prototype pattern.

37. A plurality of components according to claim 36, wherein the components each have a wooden surface of one type of wood and the individualized pattern are derived from the prototype pattern of another type of wood.
